(19) United States
(12) Patent Application Publication
(10) Pub. No.: US 2003/0113650 A1
(43) Pub. Date: Jun. 19, 2003

(54) Image forming method

(75) Inventors: Masaaki Suwabe, Minamiashigara-shi (JP); Hiroshi Kamada, Minamiashigara-shi (JP); Shuji Sato, Minamiashigara-shi (JP); Yasuo Kadokura, Minamiashigara-shi (JP); Takao Ishiyama, Minamiashigara-shi (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 10/219,489

(22) Filed: Aug. 16, 2002

(30) Foreign Application Priority Data
Aug. 17, 2001 (JP) 2001-247928

(51) Int. Cl. G03G 13/08

(52) U.S. Cl. 430/120; 430/110.4; 430/110.3; 430/111.4; 399/176

(57) ABSTRACT

Disclosed is an image forming method comprising a charging step of carrying out charging by applying voltage from the outside to a charging member which is brought into contact with an electrophotographic photoreceptor; an electrostatic latent image-forming step of forming a latent image; and a toner image-forming step of visualizing the latent image by using a developer, wherein the charging member is produced using a charging roll obtained by laminating an ionic conductive elastic material layer and a surface layer, in which an electroconductive material is dispersed, on a conductive support in this order; and the developer contains a toner which satisfies specific requirements.

### BACKGROUND OF THE INVENTION

1. Field of the Invention

The present invention relates to an image forming method in an electrophotographic method, and an electrostatic recording method or the like.

2. Description of the Related Art

Methods of making image data visible through an electrostatic latent image, such as electrophotography, are currently used in various fields. In electrophotography, an electrostatic latent image is formed on a photoreceptor through charging and exposing steps, and the latent image is developed with a developing agent containing a toner, followed by transferring and fixing steps to make the developed image visible.

Electrophotographic charging is conventionally performed by charging a photoreceptor using a corona generated by applying high voltage to a metal wire. However, ozone, NOₓ and the like are generated during in this method of corona discharging. Subsequently, the surface of the photoreceptor deteriorates, giving rise to problems concerning image generation such as blurring and black stripes, and also impaired charging efficiency. Therefore, many methods for directly charging a photoreceptor have been invented in recent years to replace the corona charging method. Amnongst these methods, in particular, a charging roll is stable in a contact state with a photoreceptor thereby suppressing the generation of pinhole leaks. Also, shelf nips are formed to create a stable condition.

In a charging roll of a contact charging system, an elastic material having a middle resistance of 10⁴ to 10⁹ Ωcm is disposed on the outer periphery of a conductive core that is made of stainless steel or a Ni plating metal or the like. Endowing the elastic material with middle resistance increases charging efficiency, and also prevents detects in the photoreceptor caused by faulty charging, which is caused by leaking of a charged current that results in voltage dropping.

An elastic material having a middle resistance is used, such as, a rubber material formed by mixing and dispersing a conductive material such as carbon black or a metal oxide therein. The charging roll that uses such an elastic material has a large unevenness in a resisting surface, so that it lacks in charging uniformity and also has a tendency to give rise to pinhole leaks to the surface of a photoreceptor and the breakdown of the surface layer of the charging roll. There are proposals for solving the aforementioned problems. Specifically, if a urethane polymer or an epichlorohydrin type elastic material is used as an ionic conductive elastic material, as described in Japanese Patent Application Laid-open (JP-A) Nos. 1-142569 and 1-277257, excellent resistive uniformity is obtained, whereby these problems are solved.

However, these ionic conductive elastic materials have a hydrophilic base, meaning that these elastic materials are easily affected by environmental changes, leading to fluctuation in conductivity. Specifically, in circumstances with low-temperature and less moisture, the water absorption quality is reduced and the ion conductivity drops. Conversely, the polymer absorbs water and conductivity is improved in circumstance with bigh-temperature and high moisture. As a result, variation in the potential of the charging material is great and the amount of the charge supplied to the photoreceptor becomes unstable when fixed voltage is maintained, subsequently rendering the image density unstable.

In order to solve this problem, a charging roll has been proposed that is provided with a surface layer cured with isocyanurate used as the ion conductive elastic material as described in JP-A No. 10-260568. In this method, the electrical and mechanical characteristics are not stabilized and water absorption is restrained. Therefore, this method is still falls short of solving the foregoing problem. Further, other proposals have been made, such as using charging rolls obtained by adding carbon black to an epichlorohydrin type elastic material and by forming the surface layer by spray coating, as described in Japanese Patent Application Laid-open (JP-A) No. 10-301362. However, there is difficulty in forming a uniform film thickness in the charging roll and is therefore still far from obtaining stable charging ability.

Another method is proposed for solving the problem in which a surface layer containing conductive particles is formed on the surface of an ion conductive elastic material by electrostatic coating, as in JP-A No. 2000-352857. This method makes it possible to coat the elastic material to the end portion thereof uniformly and sufficiently and also to control the hygroscopicity of the ionic conductive elastic material.

Another proposal involves a contact charging device using a charging roll used in contact with a photoreceptor, which is a material to be charged, as seen in JP-A No. 1-073364. From the charging device, direct current voltage and oscillating voltage are superimposingly applied. However, when the direct current voltage is applied, a portion where a toner is fused on the photoreceptor is generated by electrical and dynamic oscillation caused by oscillation of a voltage component. Thus, the wear of the surface of the photoreceptor is aggravated, causing impaired image quality. Moreover, when a high quality image is required as is the case with color prints and the like, a deelectrification step is necessary before a photoreceptor is uniformly charged. In this case, when the direct current voltage consisting of a direct current voltage component and an altering current voltage component is continuously applied to the contact charging device, particularly in a low temperature and low-moisture environment, such as a winter season, the charging ability of the contact charging device is reduced, causing defects in image quality.

In order to solve this problem, a method is proposed in which neither direct current voltage nor altering current voltage is applied to the charging roll when an image is not formed, as seen in JP-A No. 2000-352857. This ensures that charging ability is not reduced even in an environment with low temperature and low moisture, and that the charging ability can be maintained stably for a long period of time.

In recent years, progress in high image quality has been made with this type of image forming device, prompting trends such as development of small size toner for further improving image quality. The development of such small size toner is leading to improved in the reproducibility of toner image dots formed on the surface of a latent image support.

With regard to toner production, when intending to accomplish the formation of a small size toner by using a pulverizing method, which is one of the methods of producing toner, the yield of the toner during production is reduced, resulting in higher costs.

Moreover, the shape of toner particles produced by conventional kneading and pulverizing method is irregular and the surface composition is not uniform. Although the shape and surface composition of toner particles are varied corresponding to the pulverability of the material to be used and the conditions pulverizing, it is difficult to control the shaping and the surface composition of the toner particles. Also, when toner particles are produced using a highly crushable material, mechanical force due to shearing frequently causes production of toner that is too fine, causing a change in shape.

When a two-component developer is used, the above-described incidences cause the finely-pulverized toner particles to firmly adhere to a carrier, whereby chargeability of the developer is accelerated to deteriorate. When a single-component developer is used, the above- described incidents provide a broader distribution in particle size. Therefore, toners become likely to scatter or developability is lowered due to change in the shape of the toner particles, whereby image quality is frequently deteriorated.

In a case where the shape of the toner particles is irregular, the fluidity of the toner is insufficient even if an auxiliary for improving toner fluidity is added to the toner. Consequently, while the toner is used, problems arise owing to mechanical forces such as shear force, causing minute particles of the auxiliary to fall into the concave cavities of the toner particles. This causes the fluidity of the toner to decrease with the passage of time, and impairs developability, transferability, and cleanability of the toner.

On the other band, in the case of a toner to which a releasing agent is internally added, the releasing agent frequently appears at the surface of the toner particles depending on the combination of a releasing agent and a thermoplastic resin. Particularly in the case where a resin that has high elasticity due to a high molecular weight component and hence is slightly difficult to pulverize. A brittle wax such as polyethylene is combined but the polyethylene frequently appears at the surface of a toner. Such a toner is advantageous in the releasability of polyethylene during fixing and in the cleaning of non-transferred toner from a photoreceptor. However, polyethylene appearing on the surface layer of the toner particle is released from the surface of the toner by a shear force and the like in a developing device, so polyethylene is easily transferred to a developing roll, a photoreceptor, a carrier and the like. These contaminants lower the reliability of a developer.

In this situation, attempts have been made in recent years to solve the above problems by controlling the shape and surface composition of toner particles. Particularly, studies concerning the production of toners by using a wet method have been increasing. For example, Japanese Patent Application Laid-open Nos. 63-282749 and 6-250439 propose an emulsion polymerization process in which a dispersion of resin particles is prepared by emulsion polymerization while another dispersion is prepared in which a colorant is dispersed in an aqueous medium (solvent). Therefore, the two solutions are mixed and heated to form coalesced particles whose particle size correspondes to a toner particle size, followed by further raising the temperature to effect coalescence of the coalesced particles, to finally produce a toner.

In recent years, there has been an increased demand for the development of high quality images, and particularly in the formation of color images, so a significant trend to the development of small-sized toners and toners having uniform size is seen to attain highly precise image. Generally, when an image is formed using toners having wide particle distribution, there is a significant problem that toners having finer particle side in the particle size distribution cause the pollution of a developer holding member, a charging roll, a charging blade, a photoreceptor and a carrier, and the scattering of toners. It is therefore difficult to simultaneously attain high image quality and high reliability.

Also, toners having wide particle distribution have a wide distribution of chargcability of the toner itself and therefore fogging and scattering problems tend to arise in a static charge developing step and a transfer step. It is therefore difficult to obtain high reliability in these steps.

On the other hand, small-sized toners tend to cause various troubles particularly in a transfer step and constitutes a factor inhibiting improvement of a high quality image. This is considered to be because of an increase in non-electrostatic adhesion such as chemical adhesion, e.g., van der Waals force. It is necessary to control the adhesion between toners and a photoreceptor appropriately and it is therefore necessary to control the shape and surface condition of the toner.

In conventional mixing and pulverizing methods, it is difficult to produce small-sized toners having a uniform particle size as mentioned before. Toners with decreased particle size increase the strain of distortion in principle and therefore the above problem in a transfer step cannot be avoided. For this, much effect is being put into studies concerning an emulsion polymerization aggregating method in which a small-sized toner having a uniform particle size that is easily formed among wet methods.

However, in the case of producing toner particles by an emulsion polymerization aggregating method, the reaction is generally run by heating in such a direction as to change the shape of the toner particle to a more smooth sphere shape from an irregular shape, namely in such a direction so as to decrease the surface area of the toner. Therefore, this method has such a principle aspect that toners having a smaller particle size is more increased in sphericity and toners having a larger particle size are more increased in the degree of irregularity. On the other hand, it is required to design the shape of toner particles and the distribution of the particle sizes optimally so as to acquire intended results in all of the transfer quality of the shape of toners, transfer efficiency and the durability of toner.

### SUMMARY OF THE INVENTION

The point at issue when using a contact type charging device involves such a problem that because the charging roll is in contact with a material to be charged upon the principle of the contact charging device, contaminants and foreign substances of the side of the material to be charged are moved to the charging roll and accumulated, so that the charging roll tends to be placed in a contaminated condition and when the condition of contamination exceeds its allowable limit, the material to be charged cannot be charged to a desired potential and charging unevenness is caused, leading to reduced charging ability. Particularly, the use of a toner having a small particle size to obtain a highly precise color image poses the problem that the charging roll is contaminated remarkably and desired uniform charge cannot be therefore obtained.

It is an object of the present invention to solve the above point at issue and to attain the following purposes. Specifically, the invention has the object of providing an image forming method which is superior in environmental stability and repetitive stability, has good charging ability and satisfies high image quality and high reliability at the same time

Means used to solve the above problem are as follows. Specifically, the invention provides an image forming method comprising:

a charging step of carrying out charging by applying voltage from the outside to a charging member which is brought into contact with an electrophotographic photoreceptor;

a forming step of an electrostatic latent image; and

an image forming step comprising a toner image-forming to visualize the latent image by using a developer, wherein

the charging member using a charging roll laminated an ionic conductive elastic material layer and a surface layer having an electroconductive material dispersed therein, on a conductive support in this order; and

the developer contains a toner, which satisfies the conditions of:

(a) the volume average particle size D50v is 3 to 7 μm,

(b) the volume average particle size distribution index GSDv is 1.25 or less (provided that GSDv=(D84v/D16v)^{½}, where D84v is the value of a particle size at which accumulation from the small size side in the volume distribution of particle sizes is 84% and D16v, where the value of a particle size at which accumulation from the small size side in the volume distribution of particle sizes is 16%,

(c) the small particle size side-number particle size distribution index GSDp-under is 1.27 or less (provided that GSDp-under=(D50p/D16p), where D50p is the value of a particle size at which accumulation from the small size side in the number distribution of particle sizes is 50% and D16p is the value of a particle size at which accumulation from the small size side in the number distribution of particle sizes is 16%,

(d) shape factor SF1=125 to 140 (provided that SF1=(π/4)×(L²/A)×100, where L represents a maximum length and A represents a projected area),

(e) the ratio of exposure forthe releasing agent from the toner surface, whose quality is fixed X-ray photoelectron spectroscopy (XPS), is in a range from 1 to 40%, and

(f) the melting point of the releasing agent, which is measured using a differential scanning calorimeter, is 70 to 130° C. and the content of the releasing agent is 8 to 20% by weight.

The invention also provides the above method of forming an image, wherein the ionic conductive elastic material layer is prepared by compounding at least one quaternary ammonium salt or by dispersing a conductive carbon black or a metal oxide in urethane rubber or epichlorohydrin rubber.

The invention also provides the above method of forming an image, wherein a film thickness of the surface layer is in a range from 2 to 500 μm.

The invention also provides the above method of forming an image, wherein the toner satisfies the following requirements:

g) the toner comprises two types of silicon compound fine particles in a total amount of 0.5 to 10% by weight based on the mass of the toner, with the one type being median particle size of 5 to 30 nm and the other type being median particle size of 30 to 100 nm.

The invention also provides the above method of forming an image, the method comprising using of a carrier and an electrostatic latent image developing toner.

The invention also provides the above method of forming an image, wherein the resistance of the surface layer is controlled within the resistance of the ionic conductive elastic material layer with ± one-digit thereof.

The invention also provides the above method of forming an image, wherein charging is conducted by applying direct current voltage and altering current voltage.

The invention also provides the above method of forming an image, wherein neither direct current voltage nor altering current voltage is applied to the charging roll when an image is not formed during charging.

The invention also provides the above method of forming an image, wherein the toner is produced by mixing;

a resin particle dispersed solution in which at least the resin particles of 1 μm size or less are dispersed,

a colorant particles dispersed solution;

a releasing agent particles dispersed solution; and

an inorganic fine particle dispersed solution, to coalesce these particles, followed by heating the resulting dispersed solution at a temperature higher than the glass transition temperature of the resin particle so as to unite these components.

The invention also provides the above method of forming an image, wherein a metal salt is used when the coalesced particle dispersed solution is formed.

The invention also provides the above method of forming an image, wherein the toner is produced by further adding an additional particle dispersed solution, to the coalesced particle dispersed solution, followed by mixing both so as to adhere the additional particles to the coalesced particles thereby forming adhered particles.

The invention also provides the above method of forming an image, wherein the additional particles are resin particles.

The invention also provides the above method of forming an image, wherein the step of adhering the additional particles to the coalesced particles is repeated for two times or more.

The invention also provides the above method of forming an image, wherein the average particle size of colorant particles contained in the colorant particles dispersed solution is 0.8 μm or less.

The invention also provides the above method of forming an image, wherein an absolute value of an amount of a charge of a toner is in a range from 20 to 50 μc/g.

Also, the invention provides an image forming apparatus comprising:

a charging means for carrying out charging by applying voltage from the outside to a charging member, which is brought into contact with an electrophotographic photoreceptor;

an electrostatic-latent image-forming means of forming a latent image; and

a toner image-formiDg means including an image-forming device that visualizes the latent image by using a developer, wherein;

the charging member uses a charging roll laminated with an ionic conductive elastic material layer and a surface layer, on which an electroconductive material is dispersed, on a conductive support; and

the developer that comprises a toner, which satisfies the following requirements:

(a) the volume average particle size D50v is 3 to 7 μm;

(b) the volume average particle size distribution index GSDv is 1.25 or less (provided that GSDv=(D84v/D16v)^{½}, where D84v is the value of a particle size at which accumulation from the small size side in the volume distribution of particle sizes is 84%, and D16v is the value of a particle size at which accumulation from the small size side in the volume distribution of particle sizes is 16%;

(c) the small particle size side-number particle size distribution index GSDp-under is 1.27 or less (provided that GSDp-under (D50p/D16p), where D50p is the value of a particle size at which accumulation from the small size side in the number distribution of particle sizes is 50% and D16p is particle size value at which accumulation from the small size side in the particle sizes is 16%;

(d) shape factor SF1=125 to 140 (provided that SF1=(π/4)×(L²/A)×100, where L represents a maximum length and A represents a projected area),

(e) the ratio of the releasing agent to be exposed from the surface of the toner, whose ratio is measured quantitatively by X-ray photoelectron spectroscopy (XPS), is in a range from 1 to 40%; and

(f) the melting point of the releasing agent, which is measured using a differential scanning calorimeter, is 70 to 130° C. and the content of the releasing agent is 8 to 20% by weight.

The invention also provides the above image forming apparatus, wherein the film thickness of the surface layer is in a range from 2 to 500 μm.

The invention also provides the above image forming apparatus, wherein the toner satisfies the following requirement:

g) the toner contains two types of silicon compound fine particle in a total amount of 0.5 to 10% by weight based on the mass of the toner, wherein one silicon compound fine particle has a median particle size of 5 to 30 nm and another silicon compound fine particle has a median particle size of 30 to 100 nm.

Also, the invention provides a unit for an image forming apparatus comprising, as its constitutional components, an electrophotographic photoreceptor, a charging roll with a laminated an ionic conductive elastic material layer and a surface layer, in which an electroconductive material is dispersed in this order on a conductive support which is brought into contact with the electrophotographic photoreceptor; and

a developer containing a toner which satisfies the following requirements:

(a) the volume average particle size DSOv is 3 to 7 μm;

(b) the volume average particle size distribution index GSDv is 1.25 or less (provided that GSDv=(D84v/D16v)^{½}, where D84v is the value of a particle size at which accumulation from the small size side in the volume distribution of particle sizes is 84%, and where D16v is the value of a particle size at which accumulation from the small size side in the volume distribution of particle sizes is 16%;

(c) the small particle size side-number particle size distribution index GSDp-under is 1.27or less (provided that GSDp-under=(D50p/D16p), where D50p is the value of a particle size at which accumulation from the small size side in the number distribution of particle sizes is 50% and D16p is the value of a particle size at which accumulation from the small size side in the number distribution of particle sizes is 16%;

(d) shape factor SF1=125 to 140 (provided that SF1=(π/4)×L²/A)×100, where L represents a maximum length and A represents a projected area);

(e) the ratio of the releasing agent to be exposed from the surface of the toner, whose ratio is measured quantitatively by X-ray photoelectron spectroscopy (XPS), is in a range from 1 to 40%; and

(f) the melting point of the releasing agent, which is measured using a differential scanning calorimeter, is 70 to 130° C. and the content of the releasing agent is 8 to 20% by weight.

The invention also provides the above unit for an image forming apparatus, wherein the toner satisfies the following requirement:

g) the toner contains two types of silicon compound particle in a total amount of 0.5 to 10% by weight based on the mass of the toner, wherein one silicon compound particle has a median particle size of 5 to 30 nm and another silicon compound fine particle has a median particle size of 30 to 100 nm.

### DETAILED DESCRIPTION OF THE PREFERRED EMBODIMENTS

The image forming method of the present invention comprises a charging step of carrying out charging by applying voltage from the outside to a charging member which is brought into contact with an electrophotographic photoreceptor, an electrostatic latent image-forming step of forming a latent image and a toner image-forming step of visualizing the latent image by using a developer, wherein;

the above charging member is produced using a charging roll obtained by laminating an ionic conductive elastic material layer and a surface layer, in which an electroconductive material is dispersed, on a conductive support in this order; and

the above electrostatic charge image developing agent contains a toner which satisfies the requirements which will be explained later.

The structural elements in the invention will be hereinafter explained.

Electrostatic Charge Image Developing Toner

The toner (hereinafter referred simply to as “toner” as the case may be) to be used in the invention is a toner which satisfies the following requirements (a), (b), (c), (d), (e) and (f).

Requirement (a)

The volume average particle size D50v is 3 to 7 μm.

When D50v is less than 3 μm, only insufficient chargeability is obtained, so that the toner is scattered around, causing image fogging and this is undesirable. On the other hand, when D50v exceeds 7 μm, the resolution of an image is lowered and it is therefore difficult to attain high image quality.

Requirement (b)

The volume average particle size distribution index GSDv is 1.25 or less.

The volume average particle size distribution index GSDv is found from the formula: GSDv=(D84v/D16v)^{½}, where D84v is the value of a particle size at which accumulation from the small size side in the volume distribution of particle sizes is 84% and D16v is the value of a particle size at which accumulation from the small size side in the volume distribution of particle sizes is 16%. When GSDv exceeds 1.25, the vividness and resolution of an image are lowered and this is therefore undesirable.

Requirement (c)

(c) The small particle size side-number particle size distribution index GSDp-under is 1.27 or less.

The small particle size side-number particle size distribution index GSDp-under is found from the formula: GSDp-under=(D50p/D16p), where D16p is the value of a particle size at which accumulation from the small size side in the number distribution of particle sizes is 16% and D50p is the value of a particle size at which accumulation from the small size side in the number distribution of particle sizes is 50%. When GSDp-under exceeds 1.27, the ratio of toners having a small particle size is increased, which has very large influence on initial performance and also from the viewpoint of reliability. Specifically, because the adhesion of a small particle size toner is large as is known conventionally, electrostatic control tends to be difficult and the toner therefore tends to be left unremoved on a carrier when a two-component developing agent is used. In this case, if repeated mechanical force is applied, the contamination of a carrier is caused, with the result that the deterioration of a carrier is promoted. Also, because a small particle size toner has large adhesion, a reduction in developing efficiency is caused, resulting in the generation of image quality defects. In a transfer step in particular, small size components among the toners developed on the photoreceptor tend to be transferred with difficulty, resulting in low transfer efficiency, causing waste toners to increase and also causing image quality inferiors. As a result of the development of these problems, toners which are not electrostatically controlled and toners having reversed polarity are increased and contaminate the circumstance resultantly. These uncontrolled toners arc accumulated on the charging roll in particular through the photoreceptor and the like, giving rise to charging inferiors, which is undesirable.

The toner to be used in the invention has the characteristics that it has narrow particle distribution though it has a small size. Further, it has an intermediate shape between a sphere shape and an amorphous shape. It can provide a high quality image with satisfying various characteristics needed for a developing step, transfer step, cleaning step and fixing step in an electrophotographic method or electrostatic recording method by limiting the ratio of a releasing agent to be exposed from the surface of the toner within a predetermined range. Furthermore, because the adhesion of the toner to the charging roll is decreased even after a successive running operation, a high quality image can be provided for a long period of time.

Requirement (d)

Shape factor SF1=125 to 140.

The shape factor SF1 is found from the equation: SF1=(π/4)×(L²/A)×100, where L represents a maximum length of a toner particle and A represents a projected area) and is found as follows.

The toner is sprayed on a slide glass and an image observed by an optical microscope is taken in a Luzex image analyzer through a video camera to measure each maximum length and projected area of 1000 or more toner particles. These data are substituted in the above formula to calculate each shape factor and an average of the calculated shape factors is defined as the shape factor. When the shape factor exceeds 140, the fluidity of the toner is lowered, which adversely affects the transferability from the start. Also, when the shape factor SF1 is less than 125, there is the case where cleaning inferiors are caused. In this case, non-cleaned toners are taken in the charging roll to contaminate the surface of the charging roll and such a shape factor is therefore undesirable.

Requirement (e)

The ratio of the releasing agent to be exposed from the surface of the toner, which ratio is measured quantitatively by X-ray pbotoelectron spectroscopy (XPS), is in a range from 1 to 40%.

When the ratio of the releasing agent to be exposed from the surface of the toner is less than 10%, there is the case where there is a difficulty in maintaining long term preserving characteristics though there is no influence on the fixing ability in the initial stage. When a fixing machine is deteriorated, there is the case where offset on the high-temperature side and the strength of the fixed image on the low-temperature side are adversely affected. On the other hand, the ratio of the releasing agent to be exposed from the surface of the toner exceeds 40%, filming on the carrier, developing roll, photoreceptor and charging roll is probably generated though the fixing ability is not affected. Also, for example, a phenomenon that external additives to be added for imparting fluidity are embedded in the toner tends to occur.

The amount of the releasing agent to be exposed from the surface may be measured quantitatively by using a measnring instrument such as an X-ray photoelectron spectrometry (XPS) manufactured by JEOL and by separating the peaks caused by resins, pigments and waxes.

Requirement (f)

The melting point of the releasing agent which is measured using a differential scanning calorimeter is 70 to 130° C. and the content of the releasing agent is 8 to 20% by weight.

The melting point of the releasing agent is measured based upon ASTMD3418-8. The releasing agent used in the invention is a substance having a primary maximal peak at a temperature ranging from 70 to 130° C. If the melting point of the releasing agent is less than 70° C., offset tends to be caused during fixing. Also, if the melting point exceeds 130° C., the fixing temperature is made high and the smoothness of the surface of the fixed image cannot be obtained, so that the glossiness is impaired. For example, DSC-7 manufactured by Perkin Elmer is used for the measurement of the primary maximal peak. Each melting point of indium and zinc is used for the calibration of the detecting portion of the device and the melting heat of indium is used for the calibration of heating value. In the measurement of the sample, an aluminum pan is used, an empty can is set for a control and the sample is measured at a temperature rise rate of 10° C./min.

The toner according to tbe invention preferably contains an inorganic fine particle having a median particle size of 5 to 30 nm and an inorganic fine particle having a median particle size of 30 to 100 nm in a content ranging from 0.5 to 10%.

As the inorganic fine particle, silica, silica which has been processed by hydrophobic treatment, titanium oxide, alumina, calcium carbonate, magnesium carbonate, tricalcium phosphate, colloidal silica, colloidal silica which has been processed by cationic surface treatnent or colloidal silica which has been processed by anionic surface treatment is used. These inorganic fine particles are subjected in advance to dispersing treatment performed using an ultrasonic dispersing machine in the presence of an ionic surfactant. It is preferable to use colloidal silica for which this dispersing treatment is not required.

When the amount of the above inorganic fine particle to be added is less than 0.5%, only insufficient toughness is obtained when the toner is melted even by the addition of the inorganic fine particle. Not only the releasability in oilless fixing is not improved, but also coarse dispersion of the fine particle in the toner when the toner is melted increases only viscosity with the result that the spinnability is impaired with the possibility that the oilless releasability is damaged. When the amount exceeds 10%, the fluidity when the toner is melted is reduced with the possibility that the image glossiness is impaired though sufficient toughness is obtained.

The image forming method of the invention comprises a charging step of carrying out charging by applying voltage from the outside to a charging member which is brought into contact with an electrophotographic photoreceptor, an electrostatic latent image-forming step of forming a latent image and a toner image-forming step of visualizing the latent image by using a developer. The method may further comprise a transfer step of transferring the toner image formed on an electrophotographic photoreceptor to a transfer material and a cleaning step of removing the toner left on the electrophotographic photoreceptor.

The charging roll used for the charging member in the invention is formed by laminating an ionic conductive elastic material layer and a surface layer, in which an electroconductive material is dispersed, in this order on a conductive support.

Examples of materials used for the above ionic conductive elastic material layer include urethane rubber, epichlorohydrin rubber, polyether urethane rubber, polyester urethane rubber, chloroprene rubber, NBR, EPDM blended NBR rubber, SBR rubber and butyl rubber. It is preferable that an alkali metal and various alkylammonium salts having a quaternary ammonium salt structure be compounded or various conductive carbon blacks or metal oxides be dispersed in the above conductive elastic material to adjust the resistance. The amount of these materials to be compounded or dispersed is preferably in a range from 0.01 to 10% and more preferably in a range from 0.1 to 5%.

Examples of the binder resin used in the above surface layer may include polyesters, polyamides, polyurethanes, melamine resins, acryl resins such as PMMA or PMBA, polyvinylbutyrals, polyvinylacetals, polyarylates, polycarbonates, phenoxy resins, polyureas and polyvinyl acetates.

The above surface layer is formed in a thickness ranging preferably from 2 to 500 μm and more preferably from 20 to 200 μm.

The toner in the invention is preferably a toner produced by mixing a resin fine particle dispersed solution, a colorant particles dispersed solution, a releasing agent particles dispersed solution and an inorganic fine particle dispersed solution to form an coalesced particle dispersed solution, followed by beating the resulting dispersed solution to a temperature more than the glass transition temperature of the above resin fine particle to unite these components.

Specifically, the toner in the invention is preferably formed by a method involving a first step (aggregation step) of forming coalesced particles by mixing a resin fine particle dispersed solution in which at least resin particles are dispersed, a colorant particles dispersed solution, a releasing agent particles dispersed solution and an inorganic fine particle dispersed solution to prepare an coalesced particle dispersed solution, a second step (coalescence step) of adding a fine particle dispersed solution, in which fine particles are dispersed, to the above coalesced particle dispersed solution, followed by mixing the both to adhere the fine particle to the above coalesced particles thereby forming adhered particles and a third step (uniting step) of heating the adhered particles to unite the both.

The above second step is preferably carried out plural times.

The above second step is preferably a step of adding a releasing agent fine particle dispersed solution, in which a releasing agent fine particles are dispersed, followed by mixing the both, to thereby coalescence the releasing agent fine particles to the coalesced particles thereby forming adhered particles and then adding a resin-containing fine particle dispersed solution prepared by dispersing a resin-containing fine particles to the above adhered particles, followed by mixing the both, to thereby stick the resin-containing fine particles further to the adhered particles, thereby forming adhered particles.

The above second step is-preferably a step of adding a colorant fine particle dispersed solution, in which a colorant fine particles are dispersed to an coalesced particle dispersed solution of resin fine particles, followed by mixing the both, to thereby stick the colorant fine particles to the coalesced particles thereby forming adhered particles and then adding a resin-containing fine particle dispersed solution prepared by dispersing a resin-containing fine particles to the above adhered particles, followed by mixing the both, to thereby stick the resin-containing fine particles further to the adhered particles, thereby forming adhered particles.

The above second step is preferably a step of adding a resin-containing fine particle dispersed solution, in which a resin-containing fine particles are dispersed, followed by mixing the both, to thereby stick the resin-containing fine particles to the coalesced particles thereby forming adhered particles and then adding an inorganic fine particle dispersed solution prepared by dispersing an inorganic fine particles to the above adhered particles, followed by mixing the both, to thereby stick the inorganic fine particles further to the adhered particles, thereby forming adhered particles.

In the above second step, the above fine particle dispersed solution is added to the coalesced particle dispersed solution prepared in the above first step, followed by mixing the both, to thereby stick the above fine particles to the above coalesced particles, thereby forming adhered particles. The above fine particles correspond to particles which are newly added to the above coalesced particles as viewed from the above coalesced particles and therefore described as “added particles” as the case may be.

No particular limitation is imposed on a method of adding and mixing the above fine particle dispersed solution. For example,the operation may be carried out either gradually or continuously or step by step by dividing the operation into plural operations. By adding and mixing the above fine particles (added particles) in this manner, the generation of minute particles is restrained, so that the resulting electrostatic charge image developing toner can be made to have sharp particle distribution. If the addition and mixing operation is carried out step by step by dividing the operation into plural operations, layers consisting of the above fine particles are formed step by step on the above coalesced particles and the toner particle can be made to have structural variations or compositional gradients from the inside to outside of the particle, and also the surface hardness of the particle can be improved. Also, during melting in the above third step, the particle distribution is maintained and a variation in the distribution can be suppressed. At the same time, such an operation makes it unnecessary to add a surfactant and a stabilizer such as a base or acid for improving the stability during uniting and can restrict the amount of these materials to a minimum, which is advantageous in the point of cost reduction and a possibility of improvement in the quality.

Examples of polymers which are thermoplastic binding resins to be used for the above resin particles in the invention include polymers of monomers such as styrenes such as styrene, parachlorostyrene and α-methylstyrene, esters having a vinyl group such as methylacrylate, ethylacrylate, n-propylacrylate, laurylacrylate, 2-ethylbexylacrylate, methylmethacrylate, ethylmethacrylate, n-propylmethacrylate, laurylmethacrylate and 2-ethylbexylmethacrylate, vinyluitriles such as acrylonitrile and methacrylonitrile, vinyl ethers such as vinyl methyl ether and vinyl isobutyl ether, vinyl ketones such as vinyl methyl ketone, vinyl ethyl ketone and vinyl isopropenyl ketone and polyolefins such as ethylene, propylene and butadiene, or copolymers obtained by combining two or more of these monomers or mixtures of these polymers. Examples of the thermoplastic resins also include epoxy resins, polyester resins, polyurethane resins, polyamide resins, cellulose resins, polyether resins and the like, non-vinyl condensed type resins, or mixtures of these resins and the above vinyl type resins or graft polymers obtained when polymerizing vinyl type monomers in the presence of these resins. These resins may be used either singly or in combinations of two or more.

Among these resins, vinyl type resins arc particularly preferable. Vinyl type resins are advantageous in the point that a resin particle dispersed solution can be easily produced using an ionic surfactant or the like by emulsion polymerization or seed polymerization.

There is no particular limitation to a method of preparing the above dispersed solution of resin particles and a method which is properly selected according to the object may be adopted. For example, the dispersed solution may be prepared in the following manner.

When the resin in the above resin particles is homopolymers or copolymers (vinyl type resins) of vinyl type monomers such as the above esters having a vinyl group, the above vinylnitriles, the above vinyl ethers and the above vinyl ketones, the above vinyl type monomer is emulsion-polymerized or seed-polymerized in an ionic surfactant, whereby a dispersed solution in which resin particles made of a homopolymer or copolymer of a vinyl type monomer is dispersed in an ionic surfactant can be prepared.

When the resin in the above resin particles is a resin other than homopolymers or copolymers of the above vinyl type monomers and if the resin is soluble in an oily solvent having relatively low solubility in water, the resin is dissolved in the oily solvent, this solution is compounded in water together with the above ionic surfactant and a high molecular electrolyte and the resulting mixture is then micro-dispersed using a dispersing machine such as a homogenizer, followed by heating and reducing pressure to thereby vaporize the above oily solvent, whereby a dispersed solution can be prepared.

When the resin particles dispersed in the above resin particle dispersed solution are complex particles containing components other than resin particles, a dispersed solution in which these complex particles are dispersed may be prepared in the following manner. For example, an object dispersed solution may be obtained using a method in which each component of the complex particles is dissolved and dispersed in a solvent, then the solution is dispersed in water together with an appropriate dispersant in the same manner as above and the solvent is removed by heating or reducing pressure or a method in which the complex resin particles are adsorbed to the surface of latex produced by emulsion polymerization or seed polymerization by applying mecbanical shear or electrically to thereby fix these particles to the surface.

The average particle size of the above resin particles is preferably 1 μm or less and more preferably 0.01 to 1 μm. When the average particle size of the resin particles exceeds 1 μm, the particle distribution of the toner to be finally obtained becomes wide and free particles are generated, leading to reduced performance and reliability. On the other hand, when the average particle size of the resin particles falls in the above range, this is advantageous in the point that the above drawbacks are eliminated, a difference in localization between toners is decreased, dispersed solution in the toner is bettered and each dispersed solution between performances and reliabilities is reduced. The average particle size of the resin particles may be measured using, for instance, a microtrack.

When the resin in the above resin particles is a resin other than homopolymers or copolymers of the above vinyl type monomers and if the resin is soluble in an oily solvent having relatively low solubility in water, the resin is dissolved in the oily solvent, this solution is compounded in water together with the above ionic surfactant and a high molecular electrolyte and the resulting mixture is then micro-dispersed using a dispersing machine such as a homogenizer, followed by heating and reducing pressure to thereby vaporize the above oily solvent, whereby a dispersed solution can be prepared.

Examples of the colorant include various pigments such as carbon black, Chrome Yellow, Hansa Yellow, Benzidine Yellow, Indanthrene Yellow, Quinoline Yellow, Permanent Orange GTR, Pyrazolone Orange, Vulcan Orange, Watchung Red, Permanent Red, Brilliant Carmine 3B, Brilliant Carmine 6B, Du Pont Oil Red, Pyrazolone Red, Lithol Red, Rhodamine B Lake, Lake Red C, Rose Bengale, Aniline Blue, Ultramarine Blue, Chalcoil Blue, Methylene Blue Chloride, Phthalocyanine Blue, Phthalocyanine Green and Malachite Green Oxalate; and various dyes such as an acridine type, xanthene type, azo type, benzoquinone type, azine type, anthraquinone type, dioxazinc type, thiamine type, azomethine type, indigo type, thioindigo type, phthalocyanine type, aniline black type, polymethine type, triphenylmethane type, diphenylmethane type, thiazine type and thiazole type. These colorants may be used either singly or in combinations of at least two (two or more). In the latter case, the color of the toner can be arbitrarily controlled by changing tbe type of colorant (pigment) and mixing ratio. The colorant particles dispersed solution may be prepared, for example, by dispersing the colorant in a water-type medium such as the aforementioned surfactants.

The average particle size of the colorant particles in the invention is desirably 0.8 μm or less and more preferably 0.05 to 0.5 μm. When the average particle size of the colorant particles exceeds 0.8 μm, the particle distribution of the toner to be finally obtained becomes wide and free particles are generated, leading to reduced performance and reliability. When the average particle size of the colorant particles is smaller than 0.05 μm, not only the colorability in the toner is lowered but also shape controllability which is one of the features of the emulsion aggregation method is so damaged that no toner having a shape close to a sphere can be obtained.

Also, the percentage % of the numbers of particles 0.8 μm or more in size is preferably less than 10% and substantially 0%. The presence of such coarse particles impairs the stability of the aggregating step and not only generates free coarse colorant particles but also broadens the particle distribution.

The percentage % of the numbers of particles 0.05 μm or less in size is preferably less than 5%. The presence of such minute particles impairs the shape controllability in the uniting step and therefore so-called smooth particles having a shape factor SF1 of 130 or less are not obtained. On the contrary, when the average particle size of the colorant particles, the coarse particles and the minute particles are in the above ranges respectively, this is advantageous in the point that the above drawbacks arc eliminated, a difference in localization between toners is decreased, dispersed solution in the toner is bettered and each dispersed solution between performances and reliabilities is reduced.

The average particle size of the colorant particles can be measured, for example, by using a microtruck. The amount of the above colorant to be added is preferably designed to be in a range from 1 to 20% by weight.

In the invention, the above colorant may be processed by surface reforming treatment using rosin or a polymer.

The colorant processed by the above surface reforming treatment is advantageous in the point that it is sufficiently stabilized in the colorant particles dispersed solution and can therefore maintain a good dispersing condition without any aggregation among colorants, for example, even when mixed with the resin particle dispersed solution and in the aggregating step, after the colorants are dispersed so as to have a desired average particle size in the colorant particles dispersed solution. On the other hand, there is the case where the colorants which have been processed by excess surface reforming treatment are not aggregated with the resin particles but freed. Therefore, the above surface reforming treatment is carried out in a properly selected optimal condition.

Given as examples of the foregoing polymer are acrylonitrile polymers and methylmethacrylate polymers.

With regard to the condition of the above surface reforming, a polymerization method in which a monomer is polymerized in the presence of a colorant (pigment) and a phase separation method in which a colorant (pigment) is dispersed in a polymer solution and then the solubility of the polymer is lowered to precipitate the polymer on the surface of the colorant (pigment) may be used.

In the above dispersed solution prepared by dispersing a releasing agent and components (particles) such as internal additives, the releasing agent is dispersed in water together with an ionic surfactant and a high molecular electrolyte such as a high molecular acid and a high molecular base in the case where the other component is, for example, the releasing agent. This can be prepared in the following manner. Specifically, the releasing agent is micronized by applying strong shearing force by using a homogenizer or a pressure jetting type dispersing machine with beating at a temperature higher than the melting point of the releasing agent. Also, when the other component (particle) is an inorganic particle, the inorganic particle is dispersed in a water type medium such as the foregoing surfactants, whereby the preparation can be made.

Examples of materials which may be used as the above releasing agent include low molecular weight polyolefins such as polyethylene, polypropylene and polybutene, silicones having a softening point created by beating, fatty acid amides such as oleic acid amide, erucic acid amide, recinoleic acid amide and stearic acid amide, vegetable type waxes such as carnauba wax, rice wax, candelilla wax, haze wax and jojoba oil, animal waxes such as beeswax, minerals and petroleum type waxes such as montan wax, ozokerite, ceresin, paraffin wax, microcrystalline wax and Fischer-Tropsch wax and modified products of these waxes. These releasing agents may be used either singly or in combinations of two or more.

The average particle size of the foregoing other component (particle) is preferably 1 μm or less and more preferably 0.01 to 1 μm. Wben the average particle size exceeds 1 μm, the particle distribution of the toner to be finally obtained becomes wide and free particles are generated, leading to reduced performance and reliability. When the average particle size of the resin particle falls in the above range, this is advantageous in the point that the above drawbacks are eliminated, a difference in localization between toners is decreased, dispersed solution in the toner is bettered and each dispersed solution between performances and reliabilities is reduced. The foregoing average particle size is measured, for example, by a microtruck.

As the dispersion medium in the dispersed solution prepared by dispersing the foregoing resin particle dispersed solution, colorant particles dispersed solution and other components (particles), water-type media may be exemplified.

Examples of the above water-type medium include waters such as distilled water and ion exchange water and alcohols. These media may be used either singly or in combinations of two or more.

Examples of the measures to be used for preparing the foregoing various dispersed solutions include dispersing machines which are itself known, such as a rotary shearing type homogenizer and a ball mill, sand mill and dynomill using media.

As the charge control agent in the invention, various charge control agents, which are usually used, such as quaternary ammonium salt compounds, nigrosine type compounds, dyes consisting of complexes of aluminum, iron, chromium and the like and triphenylmethane type pigments may be used. Materials which art sparingly soluble in water are properly used from the viewpoint of the control of ionic strength which affects aggregation and stability when the components are united and from the viewpoint of a reduction in waste water pollution

In the invention, it is preferable to add a surfactant to the above water-type medium and to mix the both in advance.

Preferable examples of the above surfactant include anionic surfactants such as a sulfate type, sulfonate type, phosphate type and soap type; cationic surfactants such as an amine salt type and quaternary ammonium salt type and nonionic surfactants such as a polyethylene glycol type, alkylpbenolethylene oxide adduct type and polyhydric alcohol type. Among these surfactants, ionic type surfactants are preferable and anionic surfactants and cationic surfactants are more preferable.

The foregoing nonionic surfactant is preferably used in combinations with the foregoing anionic surfactant or cationic surfactant. The foregoing surfactants may be used either singly or in combinations of two or more.

Specific examples of the foregoing anionic surfactant include fatty acid soaps such as potassium laurate, sodium oleate and caster oil sodium; sulfates such as octyl sulfate, lauryl sulfate, lauryl ether sulfate and nonyl phenyl ether sulfate; sulfonates such as lauryl sulfonate, dodecyl sulfonate, dodecylbenzene sulfonate, sodium alkylnapbthalenesulfonate such as triisopropylnaphthalene sulfonate and dibutylnaphthalene sulfonate, naphthalene sulfonate formalin condensates, monooctylsulfosuccinate, dioctylsulfosuccinate, lauric acid amide sulfonate and oleic acid amide sulfonate; phosphates such as lauryl phosphate, isopropyl phosphate and nonyl phenyl ether phosphate; sulfosuccinates such as sodium dialkylsulfosuccinate, e.g., sodium dioctylsulfosuccinate, lauryldisodium sulfosuccinate and lauryldisodium polyoxyethylenesulfosuccinate.

Specific examples of the foregoing cationic surfactant include amine salts such as laurylamine hydrochloride, stcarylamine hydrochloride, oleylamine acetate, stearylamine acetate and stearylaminopropylamine acetate; and qauaternary ammonium salts such as lauryltrirnethylammonium chloride, dilauryldimethylammonium chloride, distearylammonium chloride, distearyldimethylammonium chloride, lauryldihydroxyethylmethylammonium chloride, oleylbispolyoxyethylenemethylammonium chloride, lauroylaminopropyldimethylethylammonium ethosulfate, lauroylaminopropyldimethylhydroxyethylammonium perchlorate, alkylbenzenedimethylammonium chloride and alkyltrimethylammonium chloride.

Specific examples of the foregoing nonionic surfactant include alkyl ethers such as polyoxyethylene octyl ether, polyoxyethylenc lauryl ether, polyoxyetbylene stearyl ether and polyoxyethylene oleyl ether; alkyl phenyl ethers such as polyoxyethylene octylphenyl ether and polyoxyethylene nonylphenyl ether; alkylesters such as polyoxyethylene laurate, polyoxyethylene stearate and polyoxyethylene oleate; alkylamines such as polyoxyethylene laurylamino ether, polyoxyethylene stearylamino ether, polyoxyethylene oleylamino-ether, polyoxyethylene soybean amino ether and polyoxyethylene beef tallow amino ether; alkylamides such as polyoxyethylenelauric acid amide, polyoxyethylene stearic acid amide, polyoxyethylene stearic acid amide and polyoxyethyleneoleic acid amide; vegetable oil ethers such as polyoxyethylene castor oil ether and polyoxyethylene rape oil ether; alkanol amides such as lauric acid diethanol amide, stearic acid diethanol amide and oleic acid diethanol amide; sorbitanester ethers such as polyoxyethylenesorbitan monolaurate, polyoxyethylenesorbitan monopalmitate, polyoxyethylenesorbitan monostearate, polyoxyethylenesorbitan monostearate and polyoxyethylenesorbitan monooleate.

In the invention, the dispersed solution in which particles containing at least resin particles are dispersed is prepared from the foregoing resin particle dispersed solution or by adding the foregoing colorant particles dispersed solution or the dispersed solution consisting of other components to the resin particle dispersed solution and mixing the both. Then, this particle dispersed solution is heated at a temperature ranging from ambient temperature to the glass transition temperature of the resin to thereby aggregate the resin particles with the colorant, thereby forming coalesced particles. The average particle size of the aggregated fine particles is preferably in a range from 3 to 7 μm.

The content of the foregoing resin particles in the case of mixing the foregoing resin particle dispersed solution and the foregoing colorant particles dispersed solution may be 40% by weight or less and is preferably about 2 to 20% by weight. The content of the foregoing colorant may be 50% by weight or less and is preferably about 2 to 40% by weight. Further, the content of the foregoing other component (particle) may be the order which does not inhibit the purpose of the invention and is generally very small, and is specifically, of the order of 0.01 to 5% by weight and preferably 0.5 to 2% by weight.

The toner used in the invention has a structure in which the above coalesced particles are mother particles and a coating layer of the foregoing fine particles (added particles) is formed on the mother particle. The layer of the foregoing fine particles (added particles) may be either one layer or two or more layers. The number of the layers is usually the same as the number of the times at which the foregoing adhering step is carried out.

Next, the mixed solution containing the coalesced particles may be treated by heating at a temperature higher than the softening point of the resin, generally at 70 to 120° C. to unite coalesced particles to obtain a toner particle-containing solution (toner particle dispersed solution).

Next, the resulting toner solution is subjected to centrifugation or suction filtration to separate toner particles, which are then washed with ion exchange water one to three times. Thereafter, these toner particles are separated by filtration and then washed with ion exchange water one to three times, followed by drying, whereby the toner according to the invention can be obtained.

The absolute value of the charge amount of the toner in the invention is preferably in a range from 20 to 50 μc/g and more preferably in a range from 25 to 40 μc/g. When the above charge amount is less than 20 μc/g, the background portion tends to be soiled, whereas when the charge amount exceeds 50 μc/g, image density tends to be decreased. The ratio of the charge amount of this electrostatic charge image developing toner in a summer season to that in a winter season is more preferably in a range from 0.7 to 1.3. When the above ratio is out of the foregoing preferable range, this brings about strong environmental dependency of the toner and inferior charging stability and is therefore undesirable in actual.

As to the toner in the invention, the distribution of molecular weight represented by the ratio (Mw/Mn) of the weight average molecular weight (Mw) to number average molecular weight (Mn) which are measured using gel permeation chromatography is preferably 2 to 30 and more preferably 3 to 20. When the distribution of molecular weight expressed by the above ratio (Mw/Mn) exceeds 30, only insufficient light transmittance and colorability are obtained. In the case where the toner is developed and fixed on a film in particular, the image projected through light transmission is a blurred and dark image or a non-transmitted and color-undeveloped projected image. Whereas when the ratio is less than 2, a reduction in the viscosity of the toner during to course of high temperature fixing is significant, which makes offset easily generated. On the other hand, when the distribution of molecular weight expressed by the above ratio (Mw/Mu) is in the above range, the light transmissibility and colorability are satisfactory, a reduction in the viscosity of the toner is prevented and the generation of offset can be efficiently restrained.

The toner in the invention is superior in various characteristics such as charging ability, developing ability, transferability, fixing ability and cleaning ability and also in cleaning ability over a long term. Also, it has high reliability because it exhibits and maintains the above various characteristics stably.

Also, because the toner in the invention is produced in the above method for producing a toner, it has a small average particle size and also sharp particle distribution unlike the case of producing a toner by a mixing and pulverizing process or the like.

Particles of inorganic compounds such as silica, alumina, titania or calcium carbonate and fine particles of resins such as a vinyl type resin, polyester or silicone may be added to the surface of the toner obtained by heating finally in the above manner in a dry condition by applying shearing force to thereby use these materials as a fluidity adjuvant or cleaning adjuvant. Examples of the above inorganic particles include all particles of silica, alumina, titania, calcium carbonate, magnesium carbonate, tricalcium phosphate and cerium oxide, which are usually used as external additives for the surface of a toner. Examples of the above organic particles include all particles of vinyl type resins, polyester resins and silicone resins, which are usually used as external additives for the surface of a loner. Incidentally, these inorganic particles or organic particles may be used as a fluidity adjuvant and cleaning adjuvant. Examples of the aforementioned lubricant include fatty acid amides such as ethylenebisstearic acid amide and oleic acid amide and fatty acid metal salts such as zinc stearate and calcium stearate.

No particular limitation is imposed on the developer except that it contains the aforementioned electrostatic charge image developing toner and an appropriate componential composition may be chosen according to the purpose. For instance, the developer in the invention may be prepared as a one-component type electrostatic charge image developing agent by singly using the toner according to the invention or as a two-component type electrostatic charge image developing agent by using it in combination with a carrier.

There is no particular limitation to the foregoing carrier and carriers which are itself known are exemplified. Known carriers such as resin-coated carriers as described in, for example, JP-A Nos. 62-39879 and 56-11461 may be used. There is no particular limitation to the mixing ratio of the toner according to the invention to the carrier and the mixing ratio may be properly selected according to the purpose.

The image forming method of the invention comprises a charging step, electrostatic latent image forming step and toner image forming step and may comprise a transfer step and cleaning step. The aforementioned each step itself is a usual step and is described in JP-A Nos. 56-40868 and 49-91231.

It is to be noted that the image forming method of the invention may be practiced using an image forming apparatus such as a copying machine, facsimile machine or the like which are itself known. In the image forming method of the invention, the following effects including high image quality and excellent maintainability can be obtained by combining the above charging roll and the above toner.

Accordingly, although the toner in the invention is a toner having a particle size as small as 3 to 7 μm, it has a narrow particle distribution and therefore is reduced in the number of toners having a size smaller enough to make it impossible to control the electrostatic characteristics. Therefore, the toner is reduced in soiling to the charging roll even after an image formation over a long tern and therefore the charging characteristics of the charging roll can be maintained for a long period of time. Moreover, in addition to the point that the environmental dependency of the charging roll and stability are satisfactory, a combination with the toner ensures that a high quality image can be maintained over a long term.

The above electrostatic latent image-forming step is a step for forming an electrostatic latent image on the electrostatic latent image support. The foregoing toner image-forming step is a step for developing the above electrostatic latent image by the developing agent layer on the developing agent support to form a toner image. No particular limitation is imposed on the foregoing developing agent layer as far as it contains the above electrostatic charge image developing toner of the invention. The above transfer step is a step for transferring the above toner image to a transfer material. The aforementioned cleaning step is a step for removing the developer left unremoved on the electrostatic latent image support.

### EXAMPLES

The present invention will be explained in detail by way of examples, which however, are not intended to be limiting of the present invention. Preparation of a resin fine particle dispersed solution

| | |
|---|---|
| Styrene (manufactured by Wako Pure Chemical lndustries, | 320 parts |
| Ltd.) | |
| n-Butylacrylate (manufactured by Wako Pure Chemical | 80 parts |
| Industries, Ltd.) | |
| β-carboxyethylacrylate (manufactured by Rhodia Nicca, Ltd.) | 9 parts |
| 1′10 decanediol diacrylate (manufactured by Shin-Nakamura | 1.5 parts |
| Chemical Co., Ltd.) | |
| Dodecanethiol (manufactured by Kao Corporation) | 2.7 parts |

The above materials are mixed and melted. The mixture is poured into a solution prepared by dissolving 4 g of an anionic surfactant (trade name: Dow Fax, manufactured by Dow Chemical) in 550 g of ion exchange water and the mixture solution is dispersed and emulsified in a flask. 50 g of ion exchange water in which 6 g of ammonium persulfate is dissolved is poured into the solution with stirring and mixing slowly for 10 minutes. Next, the atmosphere in the system is replaced thoroughly by nitrogen. Then, the resulting solution is heated until the system is raised to 70° C. in an oil bath with stirring the solution in the flask and the emulsion polymerization is continued in this condition for 5 hours.

Thus, a dispersed solution of an anionic resin having a center size of 210 nm, a solid content of 43%, a glass transition temperature of 51.0° C. and a molecular weight Mw of 30000 is obtained.

Preparation of a Colorant Particle Dispersed Solution

Preparation of a colorant particle dispersed solution (1)

| | |
|---|---|
| Phthalocyanine pigment (trade name: PVFASTBLUE, manu- | 50 g |
| factured by Dainichiseika Color & Chemicals Mfg. Co., Ltd.) | |
| Anionic surfactant (trade name: Neogen SC, manufactured by Dai- | 10 g |
| ichi Kogyo Seiyaku Co., Ltd.) | |
| Ion exchange water | 240 g |

The above materials are dispersed using a homogenizer (trade name: Ultratarax 750, manufactured by IKA) for 10 minutes. Thereafter, the dispersed mixture is subjected to a circulating type ultrasonic dispersing machine (trade name: RUS-600TCVP, manufactured by Nippon Seiki Seisakusho) to prepare a colorant particle dispersed solution (1).

The average panicle size of the colorants in the resulting colorant particles dispersed solution (1) is 150 nm. The number percentage of particles 0.03 μm or less in size is 4.0% and the number percentage of particles having 0.5 μm or more in size is 0.5%.

Preparation of a colorant particle dispersed solution (2)

| | |
|---|---|
| Carbon black (trade name: R330, manufactured by Cabot | 50 g |
| Corporation) | |
| Anionic surfactant (trade name: Neogen SC, manufactured by Dai- | 10 g |
| ichi Kogyo Seiyaku Co., Ltd.) | |
| Ion exchange water | 240 g |

The above materials are mixed in the same manner as in the preparation of the colorant particle dispersed solution (1) to prepare a colorant particle dispersed solution (2).

The average particle size of the colorants in the resulting colorant particles dispersed solution (2) is 155 nm. The number percentage of particles 0.03 μm or less in size is 5.0% and the number percentage of particles having 0.5 μm or more in size is 0.5%.

Preparation of a colorant particle dispersed solution (3)

| | |
|---|---|
| C.I Pigment Red 122 (trade name: ECR-185, manufactured by | 50 g |
| Dainichiseika Color & Chemicals Mfg. Co., Ltd.) | |
| Anionic surfactant (trade name: Neogen SC, manufactured by Dai- | 10 g |
| ichi Kogyo Seiyaku Co., Ltd.) | |
| Ion exchange water | 240 g |

The above materials are mixed in the same manner as in the preparation of the colorant particle dispersed solution (1) to prepare a colorant particle dispersed solution (3).

The average particle size of the colorants in the resulting colorant particles dispersed solution (3) is 165 nm. The number percentage of particles 0.03 μm or less in size is 6.0% and the number percentage of particles having 0.5 μm or more in size is 0.5%.

Preparation of a colorant particle dispersed solution (4)

| | |
|---|---|
| C.I Pigment Red 185 (manufactured by Clariant (Japan) K.K.) | 50 g |
| Anionic surfactant (trade name: Neogen SC, manufactured by Dai- | 10 g |
| ichi Kogyo Seiyako Co., Ltd.) | |
| Ion exchange water | 240 g |

The above materials are mixed in the same manner as in the preparation of the colorant particle dispersed solution (1) to prepare a colorant particle dispersed solution (4).

The average particle size of the colorants in the resulting colorant particles dispersed solution (4) is 170 nm. The number percentage of particles 0.03 μm or less in size is 7% and the number percentage of particles having 0.5 μm or more in size is 0.5%.

Preparation of a colorant particle dispersed solution (5)

| | |
|---|---|
| C.I Pigment Yellow 74 (manufactured by Clariant (Japan) K.K.) | 50 g |
| Anionic surfactant (trade name: Neogen SC, manufactured by Dai- | 10 g |
| ichi Kogyo Seiyaku Co., Ltd.) | |
| Ion exchange water | 240 g |

The above materials are mixed in the same manner as in the preparation of the colorant particle dispersed solution (1) to prepare a colorant particle dispersed solution (5).

The average particle size of the colorants in the resulting colorant particles dispersed solution (5) is 175 nm. The number percentage of particles 0.03 μm or less in size is 6% and the number percentage of particles having 0.5 μm or more in size is 0.3%.

Preparation of a Releasing Agent Particles Dispersed Solution

| | |
|---|---|
| Polyethylene wax (trade name: PW725, manufactured by Toyo- | 50 g |
| Petrolite) | |
| Anionic surfactant (trade name; Neogen SC, manufactured by Dai- | 10 g |
| ichi Kogyo Seiyaku Co., Ltd.) | |
| Ion exchange water | 240 g |

The above materials are mixed and dispersed using a homogenizer (trade name: Ultatarax 750, manufactured by IKA) for 10 minutes. Thereafter, the dispersed mixture is subjected to dispersing treatment using a pressure jetting type homogenizer to prepare a releasing agent particles dispersed solution with particles having a median particle size of 200 nm.

### EXAMPLE 1

EXAMPLE 1

| | |
|---|---|
| Ion exchange water | 500 g |
| Resin particle dispersed solution | 200 g |
| Colorant particles dispersed solution (1) | 30 g |
| Releasing agent particles dispersed solution | 60 g |
| Inorganic fine particle dispersed solution (trade name: Snowtex | 10 g |
| OL, manufactured by Nissan Chemical Industries, Ltd.) | |
| Inorganic fine particle dispersed solution (Trade name: Snowtex | 10 g |
| OS, manufactured by Nissan Chemical Industries, Ltd.) | |
| Metal salt coagulant (manufactured by Asada Kagaku, aluminum | 0.5 g |
| polychloride) | |

Coagulating Step

The above materials arc mixed and dispersed using a homogenizer (trade name: Ultratarax T50, manufactured by IKA) in a tubular stainless flask. When mixed, the resin particle dispersed solution, the colorant particles dispersed solution and the releasing agent particles dispersed solution are divided into three lots each and each lot is mixed step by step. Thereafter, the mixture is moderately heated up to 40° C. with stirring the mixture in the flask in a heating oil bath and kept for 60 minutes as it is. Thereafter, the mixture is heated to 50° C. and kept at 50° C. for 60 minutes. Then, the size of particles in the mixture is measured using a Coulter Counter (trade name: Multisizer 2, manufactured by Beckman Coulter, Inc.), to confirm that coalesced particles 4.5 μm in size are formed. Further, the temperature of the heating oil bath is raised to 52° C., at which the mixture is kept for one hour.

The particle size is measured to confirm that coalesced particles 5.0 μm in size are formed.

Sticking Step

60 g of the above resin particle dispersed solution is moderately added to the resulting dispersed solution containing coalesced particles. Further, the temperature of the heating oil bath is raised to 54° C., at which the resulting solution is kept for one hour. The particle size of the resulting adhered particles is measured to find that it is 5.6 μm.

Uniting Step

An aqueous 1 mol/L sodium hydroxide solution is added to the resulting solution containing adhered particles such that the pH is 6.0 and then the stainless flask is sealed. The solution is moderately heated up to 85° C. with continuing stirring using a magnetic seal and the solution is kept at this temperature for 60 minutes, followed by heating to 96° C. Then, an aqueous 1 mol/L nitric acid solution is added to the solution until the pH is 5.0 and the solution is kept under this condition for 5 hours.

After that, the resulting solution is cooled, subjected to filtration and washed with ion exchange water five times, followed by drying using a vacuum drier to obtain toner particles.

### EXAMPLE 2

Toner particles are produced in the same manner as in Example 1 except that the colorant particles dispersed solution (1) used in Example 1 is altered to 30 g of the colorant particles dispersed solution (2).

Coagulating Step

The above materials are mixed and dispersed using a homogenizer (trade name: Ultratarax T50, manufactured by IKA) in a tubular stainless flask in the same manner as in Example 1. Thereafter, the mixture is moderately heated up to 40° C. with stirring the mixture in the flask in a beating oil bath and kept for 60 minutes as it is. Thereafter, the mixture is heated to 50° C. and kept at 50° C. for 60 minutes. Then, the size of particles in the mixture is measured using a Coulter Counter (trade name: Multisizer 2, manufactured by Beckman Coulter, Inc.), to confirm that coalesced particles 4.8 μm in size are formed. Further, the temperature of the beating oil bath is raised to 52° C., at which the mixture is kept for one hour.

The particle size is measured to confirm that coalesced particles 5.2 μm in size are formed.

Sticking Step

60 g of the above resin particle dispersed solution is moderately added to the resulting dispersed solution containing coalesced particles. Further, the temperature of the heating oil bath is raised to 54° C., at which the resulting solution is kept for one hour. The particle size of the resulting adhered particles is measured to find that it is 5.8 μm.

Uniting Step

An aqueous 1 mol/L sodium hydroxide solution is added to the resulting solution containing adhered particles until the pH is 6.0 and then the stainless flask is sealed. The solution is moderately heated up to 85° C. with continuing stirring using a magnetic seal and the solution is kept at this temperature for 60 minutes, followed by heating to 96° C. Then, an aqueous 1 mol/L nitric acid solution is added to the solution until the pH is 5.0 and the solution is kept under this condition for 5 hours.

After that, the resulting solution is cooled, subjected to filtration and washed with ion exchange water five times, followed by drying using a vacuum drier to obtain toner particles.

### EXAMPLE 3

Toner particles are produced in the same manner as in Example 1 except that the colorant particles dispersed solution (1) used in Example 1 is altered to 30 g of the colorant particles dispersed solution (3) and 10 g of the colorant particles dispersed solution (4).

Coagulating Step

The above materials are mixed and dispersed using a homogenizer (trade name: Ultratarax T50, manufactured by IKA) in a tubular stainless flask in the same manner as in Example 1. Thereafter, the mixture is moderately heated up to 40° C. with stirring the mixture in the flask in a heating oil bath and kept for 60 minutes as it is. Thereafter, the mixture is heated to 50° C. and kept at 50° C. for 60 minutes. Then, the size of particles in the mixture is measured using a Coulter Counter (trade name: MultisizeT 2, manufactured by Beckman Coulter, Inc.), to confirm that coalesced particles 4.7 μm in size are formed. Further, the temperature of the heating oil bath is raised to 52° C., at which the mixture is kept for one hour.

The particle size is measured to confirm that coalesced particles 4.9 μm in size are formed.

Sticking Step

60 g of the above resin particle dispersed solution is moderately added to the resulting dispersed solution containing coalesced particles. Further, the temperature of the heating oil bath is raised to 54° C., at which the resulting solution is kept for one hour.

The particle size of the resulting adhered particles is measured to find that it is 5.4 μm.

Uniting Step

An aqueous 1 mol/L sodium hydroxide solution is added to the resulting solution containing adhered particles until the pH is 6.0 and then the stainless flask is sealed. The solution is moderately heated up to 85° C. with continuing stirring using a magnetic seal and the solution is kept at this temperature for 60 minutes, followed by beating to 96° C. Then, an aqueous 1 mol/L nitric acid solution is added to the solution until the pH is 5.0 and the solution is kept under this condition for 5 hours.

After that, the resulting solution is cooled, subjected to filtration and washed with ion exchange water five times, followed by drying using a vacuum drier to obtain toner particles.

### EXAMPLE 4

Toner particles are produced in the same manner as in Example 1 except that the colorant particles dispersed solution (1) used in Example 1 is altered to 30 g of the colorant particles dispersed solution (5).

Coagulating Step

The above materials are mixed and dispersed using a homogenizer (trade name: Ultratarax T50, manufactured by IKA) in a tubular stainless flask in the same manner as in Example 1. Thereafter, the mixture is moderately heated up to 40° C. with stirring the mixture in the flask in a heating oil bath and kept for 60 minutes as it is. Thereafter, the mixture is heated to 50° C. and kept at 50° C. for 60 minutes. Then, the size of particles in the mixture is measured using a Coulter Counter (trade name: Multisizer 2, manufactured by Beckman Coulter, Inc.), to confirm that coalesced particles 4.9 μm in size are formed. Further, the temperature of the heating oil bath is raised to 52° C., at which the mixture is kept for one hour.

The particle size is measured to confirm that coalesced particles 5.3 μm in size are formed.

Sticking Step

60 g of the above resin particle dispersed solution is moderately added to the resulting dispersed solution containing coalesced particles. Further, the temperature of the heating oil bath is raised to 54° C., at which the resulting solution is kept for one hour.

The particle size of the resulting adhered particles is measured to find that it is 5.8 μm.

Uniting Step

An aqueous 1 mol/L sodium hydroxide solution is added to the resulting solution containing adhered particles until the pH is 6.0 and then the stainless flask is sealed. The solution is moderately heated up to 85° C. with continuing stirring using a magnetic seal and the solution is kept at this temperature for 60 minutes. Then, an aqueous 1 mol/L nitric acid solution is added to the solution until the pH is 5.0 followed by heating to 96° C. and the solution is kept under this condition for 5 hours.

After that, the resulting solution is cooled, subjected to filtration and washed with ion exchange water five times, followed by drying using a vacuum drier to obtain toner particles.

### EXAMPLE 5

Toner particles are produced in the same manner as in Example 1 except that the uniting step is altered as shown below.

Coagulating Step

The same materials as in Example 1 are mixed and dispersed using a homogenizer (trade name: Ultratarax T50, manufactured by IKA) in a tubular stainless flask in the same manner as in Example 1. Thereafter, the mixture is moderately heated up to 40° C. with stirring the mixture in the flask in a heating oil bath and kept for 60 minutes as it is. Thereafter, the mixture is heated to 50° C. and kept at 50° C. for 60 minutes. Then, the size of particles in the mixture is measured using a Coulter Counter (trade name: Multisizer 2, manufactured by Beckman Coulter, Inc.), to confirm that coalesced particles 4.6 μm in size are formed. Further, the temperature of the heating oil bath is raised to 52° C., at which the mixture is kept for one hour.

The particle size is measured to confirm that coalesced particles 5.1 μm in size are formed.

Sticking Step

60 g of the above resin particle dispersed solution is moderately added to the resulting dispersed solution containing coalesced particles. Further, the temperature of the heating oil bath is raised to 54° C., at which the resulting solution is kept for one hour.

The particle size of the resulting adhered particles is measured to find that it is 5.6 μm.

Uniting Step

An aqueous 1 mol/L nitric acid solution is added to the resulting solution containing adhered particles until the pH is 7.0 and then the stainless flask is sealed. The solution is moderately heated up to 85° C. with continuing stirring using a magnetic seal and the solution is kept at this temperature for 60 minutes. Then, the solution is heated up to 96° C. and the solution is kept under this condition for 5 hours.

After that, the resulting solution is cooled, subjected to filtration and washed with ion exchange water five times, followed by drying using a vacuum drier to obtain toner particles.

### Comparative Example 1

Toner particles are produced in the same manner as in Example 1 except that the aggregating step is altered as shown below.

Coagulating Step

The same materials as in Example 1 are mixed and dispersed using a homogenizer (trade name: Ultratarax T50, manufactured by IKA) in a tubular stainless flask in the same manner as in Example 1. Thereafter, the mixture is moderately heated up to 45° C. with stirring the mixture in the flask in a heating oil bath and kept for 60 minutes as it is. Thereafter, the mixture is heated to 53° C. and kept at 53° C. for 60 minutes. Then, the size of particles in the mixture is measured using a Coulter Counter (trade name: Multisizer 2, manufactured by Beckman Coulter, Inc.), to confirm that coalesced particles 6.5 μm in size are formed. Further, the temperature of the beating oil bath is raised to 54° C., at which the mixture is kept for one hour.

The particle size is measured to confirm that coalesced particles 7.3 μm in size are formed.

Sticking Step

60 g of the above resin particle dispersed solution (1) is moderately added to the resulting dispersed solution containing coalesced particles. Further, the temperature of the beating oil bath is raised to 55° C., at which the resulting solution is kept for one hour.

The particle size of the resulting adhered particles is measured to find that it is 8.0 μm.

Uniting Step

An aqueous 1 mol/L sodium hydroxide solution is added to the resulting solution containing adhered particles until the pH is 6.0 and then the stainless flask is sealed. The solution is moderately heated up to 85° C. with continuing stirring using a magnetic seal and the solution is kept at this temperature for 60 minutes. Then, an aqueous 1 mol/L nitric acid solution is added to the solution until the pH is 5.0 followed by heating to 96° C. and the solution is kept under this condition for 5 hours.

After that, the resulting solution is cooled, subjected to filtration and washed with ion exchange water five times, followed by drying using a vacuum drier to obtain toner particles.

### Comparative Example 2

Toner particles are produced in the same manner as in Example 1 except that the amount of the ion exchange water is altered to 800 g and the coagulant is altered to 0.5 g of a cationic surfactant (trade name: Sanisol B50, manufactured by Kao Corporation) from the metal salt coagulant.

Coagulating Step

The above materials are mixed and dispersed using a homogenizer (trade name: Ultratarax TS50, manufactured by IKA) in a tubular stainless flask in the same manner as in Example 1. Thereafter, the mixture is moderately heated up to 40° C. with stirring the mixture in the flask in a heating oil bath and kept for 60 minutes as it is. Thereafter, the mixture is heated to 52° C. and kept at 52° C. for 60 minutes. Then, the size of particles in the mixture is measured using a Coulter Counter (trade name: Multisizer 2, manufactured by Beckman Coulter, Inc.), to confirm that coalesced particles 4.5 μm in size are formed. Further, the temperature of the heating oil bath is raised to 54° C., at which the mixture is kept for one hour.

The particle size is measured to confirm that coalesced particles 4.9 μm in size are formed.

Sticking Step

60 g of the above resin particle dispersed solution is moderately added to the resulting dispersed solution containing coalesced particles. Further, the temperature of the heating oil bath is raised to 55° C., at which the resulting solution is kept for one hour.

The particle size of the resulting adhered particles is measured to find that it is 5.5 μm.

Uniting Step

An aqueous 1 mol/L sodium hydroxide solution is added to the resulting solution containing adhered particles until the pH is 6.0 and then the stainless flask is sealed. The solution is moderately heated up to 96° C. with continuing stirring using a magnetic seal and then, 1 mol/L nitric acid is added to the solution until the pH is 5.0 and the solution is kept under this condition for 5 hours.

After that, the resulting solution is cooled, subjected to filtration and washed with ion exchange water five times, followed by drying using a vacuum drier to obtain toner particles.

### Comparative Example 3

Toner particles are produced in the same manner as in Example 1 except that the pH in the uniting step is altered as shown below.

Coagulating Step

The same materials as in Example 1 are mixed and dispersed using a homogenizer (trade name: Ultratarax T50, manufactured by IKA) in a tubular stainless flask in the same manner as in Example 1. Thereafter, the mixture is moderately heated up to 40° C. with stirring the mixture in the flask in a hcating oil bath and kept for 60 minutes as it is. Thereafter, the mixture is heated to 50° C. and kept at 50° C. for 60 minutes. Then, the size of particles in the mixture is measured using a Coulter Counter (trade name: Multisizer 2, manufactured by Beckman Coulter, Inc.), to confirm that coalesced particles 4.7 μm in size are formed. Further, the temperature of the heating oil bath is raised to 52° C., at which the mixture is kept for one hour.

The particle size is measured to confirm that coalesced particles 5.0 μm in size are formed.

Sticking Step

60 g of the above resin particle dispersed solution is moderately added to the resulting dispersed solution containing coalesced particles. Further, the temperature of the heating oil bath is raised to 54° C., at which the resulting solution is kept for one hour.

The particle size of the resulting adhered particles is measured to find that it is 5.7 μm.

Uniting Step

An aqueous 1 mol/L sodium hydroxide solution is added to the resulting solution containing adhered particles until the pH is 8.0 and then the stainless flask is sealed. The solution is moderately heated up to 96° C. with continuing stirring using a magnetic seal and then kept for 5 hours as it is without adjusting the pH.

After that, the resulting solution is cooled, subjected to filtration and washed with ion exchange water five times, followed by drying using a vacuum drier to obtain toner particles.

### Comparative Example 4

Toner particles are produced in the same manner as in Example 1 except that the pH in the uniting step is altered as shown below.

Coagulating Step

The above materials are mixed and dispersed using a homogenizer (trade name: Ultratarax T50, manufactured by IKA) in a tubular stainless flask in the same manner as in Example 1. Thereafter, the mixture is moderately heated up to 40° C. with stirring the mixture in the flask in a heating oil bath and kept for 60 minutes as it is. Thereafter, the mixture is heated to 50° C. and kept at 50° C. for 60 minutes. Then, the size of particles in the mixture is measured using a Coulter Counter (trade name: Multisizer 2, manufactured by Beckman Coulter, Inc.), to confirm that coalesced particles 4.7 μm in size are formed. Further, the temperature of the heating oil bath is raised to 52° C., at which the mixture is kept for one hour.

The particle size is measured to confirm that coalesced particles 5.0 μm in size are formed.

Sticking Step

60 g of the above resin particle dispersed solution is moderately added to the resulting dispersed solution containing coalesced particles. Further, the temperature of the heating oil bath is raised to 54° C., at which the resulting solution is kept for one hour.

The particle size of the resulting adhered particles is measured to find that it is 5.7 μm.

Uniting Step

An aqueous 1 mol/L sodium hydroxide solution is added to the resulting solution containing adhered particles until the pH is 6.0 and then the stainless flask is sealed. The solution is moderately heated up to 96° C. with continuing stirring using a magnetic seal and then 1 mol/L nitric acid is added until the pH is 3.5, at which the solution is kept for 5 hours.

After that, the resulting solution is cooled, subjected to filtration and washed with ion exchange water five times, followed by drying using a vacuum drier to obtain toner particles.

### Comparative Example 5

Toner particles are produced in the same manner as in Example 1 except that the condition in the uniting step is altered as shown below.

Coagulating Step

The above materials are mixed and dispersed using a homogenizer (trade name: Ultratarax T50, manufactured by IKA) in a tubular stainless flask in the same manner as in Example 1. Thereafter, the mixture is moderately heated up to 40° C. with stirring the mixture in the flask in a heating oil bath and kept for 60 minutes as it is. Thereafter, the mixture is heated to 50° C. and kept at 50° C. for 60 minutes. Then, the size of particles in the mixture is measured using a Coulter Counter (trade name: Multisizer 2, manufactured by Beckman Coulter, Inc.), to confirm that coalesced particles 4.6 μm in size are formed. Further, the temperature of the heating oil bath is raised to 52° C., at which the mixture is kept for one hour.

The particle size is measured to confirm that coalesced particles 5.1 μm in size are formed.

Sticking Step

60 g of the above resin particle dispersed solution is moderately added to the resulting dispersed solution containing coalesced particles. Further, the temperature of the heating oil bath is raised to 54° C., at which the resulting solution is kept for one hour.

The particle size of the resulting adhered particles is measured to find that it is 5.6 μm.

Uniting Step

An aqueous 1 mol/L sodium hydroxide solution is added to the resulting solution containing adhered particles such that the pH is 7.0 and then the stainless flask is sealed. The solution is moderately heated up to 97° C. with continuing stirring using a magnetic seal and then the solution is kept for 10 hours.

After that, the resulting solution is cooled, subjected to filtration and washed with ion exchange water five times, followed by drying using a vacuum drier to obtain toner particles.

Evaluation of the Characteristics of the Toner

The toners obtained after dried are evaluated for the characteristics shown below.

Volume particle distribution index (GSDv); Square root of D84/D16 in the volume particle size distribution.

Number lower particle distribution index (GSDn-under); D50/D16 in the number particle distribution.

Shape factor SF1; Calculated from the value measured by an image analysis method (square of the maximum length×π/projected area)×(100/4).

Amount of wax disposed from the surface; Quantitation by CIS peak separation in an X-ray photoelectron spectrometry (XPS).

Amount of silica in the toner; Quantitation by fluorescent X-ray analysis.

Production of a Developer

Hydrophobic silica (trade name: TS720, manufactured by Cabot) is added to 50 g of the resulting electrostatic charge image developing toner and the mixture is blended using a sample mill.

The blended product is weighed such that the concentration of the toner is 5% based on a ferrite carrier coated with 1% polymethylmethacrylate (Soken Chemical & Engineering Co., Ltd.) and having an average particle size of 50 μm and the both is mixed with stirring in a ball mill for 5 minutes to prepare a developer.

Production of a Charging Roll

Using a shaft (stainless core bar having a size of 8 mm) as the conductive support 101, an elastic material layer having a middle resistance is formed using the following formulation and a processing method.

| | |
|---|---|
| GECO type epichlorohydrin raw material rubber | 100 parts by weight |
| (trade name: Epichroma CG102, manufactured by | |
| Daiso Co., Ltd., compositional ratio: 40 mol % of | |
| epichlorohydrin, 56 mol % of ethylene oxide and | |
| 4 mol % of allyl glycidyl ether) | |
| Calcium carbonate (trade name: Tama Pearl | 30 parts by weight |
| TR-222H, manufactured by Okutama Kogyo Co., | |
| Ltd. | |
| Sab (trade name: Neofactis U-8, manufactured by | 10 parts by weight |
| Tenman Sab Kako) | |
| Tetramethylammonium chloride (trade name: | 1.0 parts by weight |
| Elegance R115, manufactured by Nippon Jushi) | |
| Srearic acid (trade name: Fatty Acid SA-200, manu- | 0.5 parts by weight |
| factured by Asahi Denka Kogyo K.K.) | |
| Vulcanization accelerator (trade name: Noksera TT, | 1.0 parts by weight |
| manufactured by Ouchishinko Chemical Industrial | |
| Co., Ltd.) | |
| Vulcanization accelerator (trade name: Noksera DM, | 1.5 parts by weight |
| manufactured by Ouchishinko Chemical Industrial | |
| Co., Ltd.) | |
| Vulcanization accelerator (trade name: Balnoc R, | 1.0 parts by weight |
| manufactured by Ouchishinko Chemical Industrial | |
| Co., Ltd.) | |
| Vulcanizing agent (trade name: Sulfax, manu- | 0.25 parts by weight |
| factured by Tsurumi kagakn) | |

The above components are kneaded to make a compound having a uniform composition and the compound is molded on the foregoing stainless core bar by first vulcanization (boiler, 4.5×102 kPa, 150° C.×1 hour) and second vulcanization (155° C.×7 hours) into a coating layer having an outside size of 14 mm and a length of 310 mm, thereby forming a roller-like middle resistance elastic material layer. The resistance of this middle resistance elastic roller is 2×10⁷ Ωcm and the hardness of the roller is 38 degrees. Next, 5 parts of conductive carbon (trade name: FW200, manufactured by Degusa) and 10 parts by weight of a fluororesin fine powder (Rublon L-5, manufactured by Daikin Industries, Ltd.) are mixed with and dispersed in 80 parts of a straight-chain polyester resin (trade name: Biron 30SS, manufactured by Toyobo Co., Ltd.) and 20 parts of a melamine resin (trade name: Super Beckamine G-821-60, manufactured by Dainippon Ink and Chemicals, Incorporated) by using a sand mill.

Next, the foregoing dispersed solution is diluted with xylene (the ratio of xylene is 150 parts by weight to 100 parts by weight of the dispersed solution) to form a surface layer-forming paint, whose viscosity is then adjusted. The shaft is masked with the paint with leaving a gap corresponding to the film thickness from the part at which the shaft is in contact with the end of the elastic material layer. Then, a surface layer is formed on the entire surface of the elastic material layer of the conductive rubber roll by using a Bell type electrostatic coater (manufactured by Landsbirg Industry) such that the thickness of the film when dried is 35 μm. Thereafter, this surface layer is dried at 160° C. for 30 minutes to produce a charging roll.

The volume resistivity of this charging roll is measured at an applied voltage of 100 V by using a resistance measuring cell (trade name: 16008A, manufactured by YHP) and an ohm-meter (trade name: R8340A, manufactured by Advantest Corporation). The volume resistivity of the charging roll shows 10^{5.2} Ωcm. The resistance of the surface layer is 10^{4.5} Ωcm and a difference in resistance between the ionic conductive elastic material layer and the surface layer is 0.7 digits. Also, the breakdown voltage is measured, to find that it is 2200 V. The surface coating ratio at this time is 95.6%. The surface coating ratio is calculated using the following formula.

Surface coating ratio=(total surface area of the surface layer/total surface area of the charging roll)×100

Evaluation of the Developer in an Actual Machine

The charging roll is set in a manner as to rotate in contact with a photoreceptor in a copying machine. The charging roll is combined each of the toners of examples and comparative examples and subjected to a continuous running test for copying 4000 sheets under an environment of 23° C.×55% RH while voltage obtained by superimposing a 750 V DC power source on AC power source of 2 kV and 2 kHz is applied to the charging roll from a power source only when forming an image.

The results of the above evaluation are shown in Table.

TABLE 1

| | Volumetric | | | Shape | Amount of wax to | Amount of | Toner | Print image quality |
|---|---|---|---|---|---|---|---|---|
| | average particle | | GSDp- | factor | be exposed from | silica in the | adhering to the | after a continuous |
| | size | GSDs | under | SFI | the surface (%) | toner (%) | charging roll | running test |
| Example 1 | 5.6 | 1.21 | 1.24 | 127 | 17 | 2.4 | Good | Good |
| Example 2 | 5.8 | 1.21 | 1.24 | 128 | 18 | 2.4 | Good | Good |
| Example 3 | 5.4 | 1.23 | 1.26 | 132 | 24 | 2.9 | Good | Good |
| Example 4 | 5.8 | 1.22 | 1.25 | 130 | 20 | 2.3 | Good | Good |
| Example 5 | 5.6 | 1.22 | 1.24 | 135 | 28 | 2.2 | Good | Good |
| Comparative | 8.0 | 1.19 | 1.23 | 131 | 22 | 2.8 | Good | Gritted |
| Example 1 | | | | | | | | |
| Comparative | 5.5 | 1.23 | 1.31 | 128 | 26 | 1.6 | Largely stuck | Image void is found |
| Example 2 | | | | | | | | |
| Comparative | 5.7 | 1.21 | 1.23 | 143 | 31 | 1.1 | Good | Gritted |
| Example 3 | | | | | | | | |
| Comparative | 5.7 | 1.21 | 1.23 | 115 | 8 | 1.3 | Largely stuck | Image void is found |
| Example 4 | | | | | | | | |
| Comparative | 5.6 | 1.23 | 1.26 | 131 | 47 | 1.9 | Largely stuck | Image void is found |
| Example 5 | | | | | | | | |

According to the present invention, it is possible to provide an image forming method which is superior in environmental stability and repetitive stability, has good charging ability and satisfies high image quality and high reliability at the same time.

What is claimed is:

1. An image forming method comprising:
a charging step of carrying out charging by applying voltage from the outside to a charging member which is brought into contact with an electropbotographic photoreceptor;
a forming step of an electrostatic latent image; and
an image forming step comprising a toner image-forming to visualize the latent image by using a developer, wherein
the charging member using a charging roll laminated an ionic conductive elastic material layer and a surface layer having an electroconductive material dispersed therein, on a conductive support in this order; and
the developer contains a toner, which satisfies the conditions of:
(a) the volume average particle size D50v is 3 to 7 μm,
(b) the volume average particle size distribution index GSDv is 1.25 or less (provided that GSDv=(D84v/D16v)^{½}, where D84v is the value of a particle size at which accumulation from the small size side in the volume distribution of particle sizes is 84% and D16v, where the value of a particle size at which accumulation from the small size side in the volume distribution of particle sizes is 16%,
(c) the small particle size side-number particle size distribution index GSDp-under is 1.27 or less (provided that GSDp-under=(D50p/D16p), where D50p is the value of a particle size at which accumulation from the small size side in the number distribution of particle sizes is 50% and D16p is the value of a particle size at which accumulation from the small size side in the number distribution of particle sizes is 16%,
(d) shape factor SF1=125 to 140 (provided that SF1=(π/4)×(L²/A)×100, where L represents a maximum length and A represents a projected area),
(e) the ratio of exposure forthe releasing agent from the toner surface, whose quality is fixed X-ray photoelectron spectroscopy (XPS), is in a range from 1 to 40%, and
(f) the melting point of the releasing agent, which is measured using a differential scanning calorimeter, is 70 to 130° C. and the content of the releasing agent is 8 to 20% by weight.

2. An image forming method according to claim 1, wherein the ionic conductive elastic material layer is prepared by compounding at least one quaternary ammonium salt or by dispersing a conductive carbon black or a metal oxide in urethane rubber or epichlorobydrin rubber.

3. An image forming method according to claim 1, wherein a film thickness of the surface layer is in a range from 2 to 500 μm.

4. An image forming method according to claim 1, wherein the toner satisfies the following requirements:
g) the toner comprises two types of silicon compound fine particles in a total amount of 0.5 to 10% by weight based on thc mass of the toner, with the one type being median particle size of 5 to 30 nm and the other type being median particle size of 30 to 100 nm.

5. An image forming method according to claim 1, which comprises usage of a carrier and a toner.

6. An image forming method according to claim 1, wherein the resistance of the surface layer is controlled within the resistance of the ionic conductive elastic material layer with ± one-digit thereof.

7. An image forming method according to claim 1, wherein charging is conducted by applying direct current voltage and altering current voltage.

8. An image forming method according to claim 1, wherein neither direct current voltage nor altering current voltage is applied to the charging roll when an image is not formed during charging.

9. An image forming method according to claim 1, wherein the toner is produced by mixing;
a resin particle dispersed solution in which at least the resin particles of 1 μm size or less are dispersed;
a colorant particles dispersed solution;
a releasing agent particles dispersed solution; and
an inorganic fine particle dispersed solution, to coalesce these particles, followed by heating the resulting dispersed solution at a temperature higher than the glass transition temperature of the resin particle so as to unite these components.

10. An image forming method according to claim 9, wherein a metal salt is used when the coalesced particle dispersed solution is formed.

11. An image forming method according to claim 9, wherein the toner is produced by further adding an additional particle dispersed solution, to the coalesced particle dispersed solution, followed by mixing both so as to adhere the additional particles to the coalesced particles thereby forming adhered particles.

12. An image forming method according to claim 11, wherein the additional particles are resin particles.

13. An image forming method according to claim 11, wherein the step of adhering the additional particles to the coalesced particles is repeated for two times or more.

14. An image forming method according to claim 9, wherein the average particle size of colorant particles contained in the colorant particles dispersed solution is 0.8 μm or less.

15. An image forming method according to claim 1, wherein an absolute value of an amount of a charge of a toner is in a range from 20 to 50 μc/g.

16. An image forming apparatus comprising:
a charging means for carrying out charging by applying voltage from the outside to a charging member, which is brought into contact with an electrophotographic photoreceptor;
an electrostatic latent image-forming means of forming a latent image; and
a toner image-forming means including an image-forming device that visualizes the latent image by using a developer, wherein;
the charging member uses a charging roll laminated with an ionic conductive elastic material layer and a surface layer, on which an electrocondoctive material is dispersed, on a conductive support; and
the developer that comprises a toner, which satisfies the following requirements:
(a) the volume average particle size D50v is 3 to 7 μm;
(b) the volume average particle size distribution index GSDv is 1.25 or less (provided that GSDv=(D84v/D16v)^{½}, where D84v is the value of a particle size at which accumulation from the small size side in the volume distribution of particle sizes is 84%, and D16v is the value of a particle size at which accumulation from the small size side in the volume distribution of particle sizes is 16%;
(c) the small particle size side-number particle size distribution index GSDp-under is 1.27 or less (provided that GSDp-under=(D50p/D16p), where D50p is the value of a particle size at which accumulation from the small size side in the number distribution of particle sizes is 50% and D16p is particle size value at which accumulation from the small size side in the particle sizes is 16%;
(d) shape factor SF1=125 to 140 (provided that SF1=(π/4)×(L²/A)×100, where L represents a maximum length and A represents a projected area);
(e) the ratio of the releasing agent to be exposed from the surface of the toner, whose ratio is measured quantitatively by X-ray photoelectron spectroscopy (XPS), is in a range from 1 to 40%; and
(f) the melting point of the releasing agent, which is measured using a differential scanning calorimeter, is 70 to 130° C. and the content of the releasing agent is 8 to 20% by weight.

17. An image forming apparatus according to claim 16, wherein the film thickness of the surface layer is in a range from 2 to 500 μm.

18. An image forming apparatus according to claim 16, wherein the toner satisfies the following requirement:
g) the toner contains two types of silicon compound fine particle in a total amount of 0.5 to 10% by weight based on the mass of the toner, wherein one silicon compound fine particle has a median particle size of 5 to 30 nm and another silicon compound fine particle has a median particle size of 30 to 100 nm.

19. A unit for an image forming apparatus comprising, as its constitutional components, an electrophotographic photoreceptor, a charging roll with a laminated an ionic conductive elastic material layer and a surface layer, in which an electroconductive material is dispersed in this order on a conductive support which is brought into contact with the electrophotographic photoreceptor; and
a developer containing a toner which satisfies the following requirements:
(a) the volume average particle size D50v is 3 to 7 μm;
(b) the volume average particle size distribution index GSDv is 1.25 or less (provided that GSDv=(D84v/D16v)^{½}, where D84v is the value of a particle size at which accumulation from the small size side in the volume distribution of particle sizes is 84%, and where D16v is the value of a particle size at which accumulation from the small size side in the volume distribution of particle sizes is 16%;
(c) the small particle size side-number particle size distribution index GSDp-under is 1.27 or less (provided that GSDp-under=(D50p/D16p), where D50p is the value of a particle size at which accumulation from the small size side in the number distribution of particle sizes is 50% and D16p is the value of a particle size at which accumulation from the small size side in the number distribution of particle sizes is 16%;
(d) shape factor SF1=125 to 140 (provided that SF1=(π/4)×L²/A)×100, where L represents a maximum length and A represents a projected area);
(e) the ratio of the releasing agent to be exposed from the surface of the toner, whose ratio is measured quantitatively by X-ray photoelectron spectroscopy (XPS), is in a range from 1 to 40%; and
(f) the melting point of the releasing agent, which is measured using a differential scanning calorimeter, is 70 to 130° C. and the content of the releasing agent is 8 to 20% by weight.

20. A unit for an image forming apparatus according to claim 19, wherein the toner satisfies the following requirement:
g) the toner contains two types of silicon compound particle in a total amount of 0.5 to 10% by weight based on the mass of the toner, wherein one silicon compound particle has a median particle size of 5 to 30 nm and another silicon compound fine particle has a median particle size of 30 to 100 nm.
